(19) United States
(12) Patent Application Publication
(10) Pub. No.: US 2014/0258780 A1
(43) Pub. Date: Sep. 11, 2014

(54) MEMORY CONTROLLERS INCLUDING TEST MODE ENGINES AND METHODS FOR REPAIR OF MEMORY OVER BUSSES USED DURING NORMAL OPERATION OF THE MEMORY

(71) Applicant: MICRON TECHNOLOGY, INC., Boise, ID (US)

(72) Inventor: Dean C. Eyres, Boise, ID (US)

(73) Assignee: Micron Technology, Inc., Boise, ID (US)

(21) Appl. No.: 13/785,668

(22) Filed: Mar. 5, 2013

(51) Int. Cl. G06F 11/27

(52) U.S. Cl. CPC G06F 11/27
USPC 714/30

(57) ABSTRACT

Examples of memory controllers are described that may repair a memory using a bus between the memory controller and the memory. The memory controllers may include a test mode engine able to place the memory into a test mode of operation using a combination of signals over the bus, which combination of signals may be illegal in normal operation. The memory system controllers may include a BIST engine for testing the memory and obtaining information regarding memory fail information. The test mode engines may be configured to adjust a clock frequency during the test mode of operation, including stopping a clock signal in some examples between test mode commands.

### TECHNICAL FIELD

Embodiments of the invention relate generally to semiconductor memory, and examples described include memory controllers and methods for repair of semiconductor memory.

### BACKGROUND

Fabrication of semiconductor memory devices and other semiconductor devices containing memory (collectively referred to hereinafter as “memory”) is an imperfect process. The imperfections in the fabrication process may lead to imperfections in the semiconductor devices themselves. Such imperfections might manifest themselves as, for example, semiconductor crystallinity defects or electrical connector discontinuities. Naturally, such imperfections in the semiconductor devices can lead to errors in storing and retrieving data from memory cells contained within such semiconductor devices. For this reason among others, it may be advantageous to test memory cells on a semiconductor device to ensure they are operational.

Memory testing was originally only intended to identify faulty devices which were then discarded. As memory cell density has increased, however, the failure rates of devices containing memory cells can become intolerably large leading to too many devices being discarded. In an effort to improve device yields, methods for repairing defective devices have been developed. More specifically, semiconductor devices with repairable memory typically include redundant rows or columns of memory cells. During testing of such devices, the addresses of the faulty rows or columns of cells may be identified and the addresses saved. These faulty memory rows or columns of cells may then be effectively replaced by one of the redundant rows or columns. This may typically be accomplished through the use of programmable elements such as fuses or anti-fuses (hereinafter referred to collectively as ‘fuses’) which are used to create open and closed circuit paths within the memory or its associated decoders. Through the use of a laser, for example, an appropriate combination of fuses can be “blown” thereby electrically isolating defective cells while electrically connecting the redundant cells in their place.

Most typically, both the testing and repair of semiconductor devices has been accomplished through the use of complex test equipment that is physically connected to each memory die or module. Moreover, it is not uncommon that testing of the devices is done on one piece of equipment and the repair on another. Obviously, testing, repairing and then retesting of the repaired devices can take a great deal of time when the devices have to be moved from one machine to another. To help mitigate this problem, circuitry can be built into the semiconductor device itself to aid in the testing and repair processes.

Validation and repair of prior art semiconductor devices internal repair circuitry still generally requires the use of a test system. The test system is used to electrically interface with a device die using externally-accessible connections to the device die. Once the test system is connected, the system may be used to issue standard memory commands (e.g. patterns) to the die, some of which may be special testmode commands. These testmode commands may be used to enable testmode circuitry or other repair circuitry. When a test failure occurs, certain types of repair circuitry (if enabled) may capture the address or other fail information of any memory failures. Once the address or addresses have been captured, the test system may be used to control and direct the repair. After repair is complete, the test system is typically used to run the test patterns again to ensure the repair was completed properly and otherwise verify the integrity of the device.

FIG. 1 is a schematic illustration of a memory system including memory repair equipment in accordance with the prior art. A memory component, e.g. memory die 100 includes a memory array 140, row and column decoders 120, redundant row and column decoders 125 and a control module 110. The memory die 100 may also contain other logic or an application specific integrated circuit (ASIC), not shown in FIG. 1. As was described above, a test system 105 may interface directly with the die 100, for instance, over a bus. The test system 105 may be able to implement repair algorithms to repair the memory die 100. The interface (e.g., bus) is generally made using externally-accessible connectors 102 of the memory die 100. The test system 105 may, for example, run tests on the memory array 140 and related circuitry. A typical test might write data to the memory array 140 and then later read the data. If the read data fails, the test system 105 may store the failure address. Alternatively, if the memory die 105 itself contains repair circuitry, e.g. repair circuitry 160 and that circuitry is enabled, the memory die 100 may store fails internally. The failure address, whether stored internally or externally, may be used to program a fuse bank in the redundant row and column decoders 125. Once the appropriate fuses have been programmed, the redundant row and column decoders 125 are able to replace a received address of the faulty memory cells with an address of redundant cells in the memory array 140.

Once repaired, the memory die 100 may be connected to a memory controller (e.g. the memory die 100 may be connected to a memory controller using the externally-accessible connectors 102). Because the memory die 100 has undergone prior testing and repair, it is generally assumed to be a good memory die that will be usable by the memory controller. If the memory die 100 fails when connected to the memory controller during normal operation, it would need to be disconnected from the memory controller to be further repaired.

### BRIEF DESCRIPTION OF THE DRAWINGS

FIG. 1 is a schematic illustration of a memory system including memory repair equipment in accordance with the prior art.

FIG. 2 is a schematic illustration of a memory system arranged in accordance with an embodiment of the present invention.

FIG. 3 is a timing diagram illustrating signal transitions corresponding to a command providing data to a memory during test mode in accordance with an embodiment of the present invention.

FIG. 4 is a timing diagram illustrating signal transitions corresponding to a command reading data from a memory during test mode in accordance with an embodiment of the present invention.

FIG. 5 is a schematic illustration of a memory system arranged in accordance with another embodiment of the present invention.

FIG. 6 is a schematic illustration of a memory system arranged in accordance with another embodiment of the present invention.

FIG. 7 is a flowchart illustrating operation of a memory system in accordance with an embodiment of the present invention.

### DETAILED DESCRIPTION

Certain details are set forth below to provide a sufficient understanding of embodiments of the invention. However, it will be clear to one skilled in the art that embodiments of the invention may be practiced without various aspects of these particular details. In some instances, well-known circuits, control signals, timing protocols, and software operations have not been shown in detail in order to avoid unnecessarily obscuring the described embodiments of the invention.

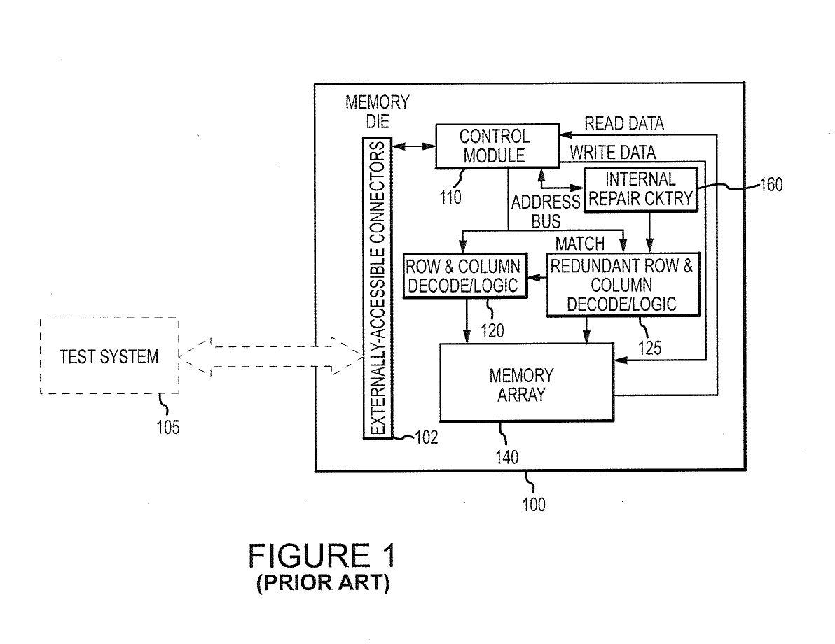

As discussed with reference to FIG. 1, typical memory test and repair procedures involve connecting externally-accessible connectors of one or more memory components, e.g. dies or modules, to a test system. Once tested and/or repaired, the memory components, e.g. dies, may then be connected to and/or integrated with a memory controller for use in a functional system with normal memory operation. Once the component is included in a memory system (e.g. connected to a memory controller), the component is assumed to be good and may not be further tested, and cannot be further repaired. The memory controller, accordingly, would have only limited, if any, ability to test and no ability to repair memory connected to the memory controller. Instead, the memory controller would only function to read data from and write data to the memory components connected to it using normal memory commands. In the case of some conventional memory components, it may be relatively simple to remove and replace components (e.g. due to the externally-accessible connectors 102 of FIG. 1) should a component fail after integration into a system.

However, as memory systems have evolved, larger amounts of memory have been employed in tighter integration with the remaining system components, such as a memory controller. Accordingly, it may be difficult to remove memory components or connect memory components to other systems (e.g. a test system) for memory test and/or repair. Further, even if memory repair is performed on memory prior to connection with a memory controller, the component may develop further failures either during use or as a result of connection with the memory controller. For example, if a memory is stressed by soldering the memory into a larger system, the memory may develop additional failures. Embodiments of the present invention may accordingly provide memory controllers capable of conducting memory repair on memory connected to (e.g. in communication with) the memory controller. In some examples, memory controllers described herein may further be configured to test memory connected to the memory controller. Example memory controllers described herein may include controllers having a test mode engine. The test mode engine may be configured to repair and/or test memory over the same electrical connections (e.g. pins) typically used by the memory controller to provide normal memory commands (e.g. commands, address, and data signals).

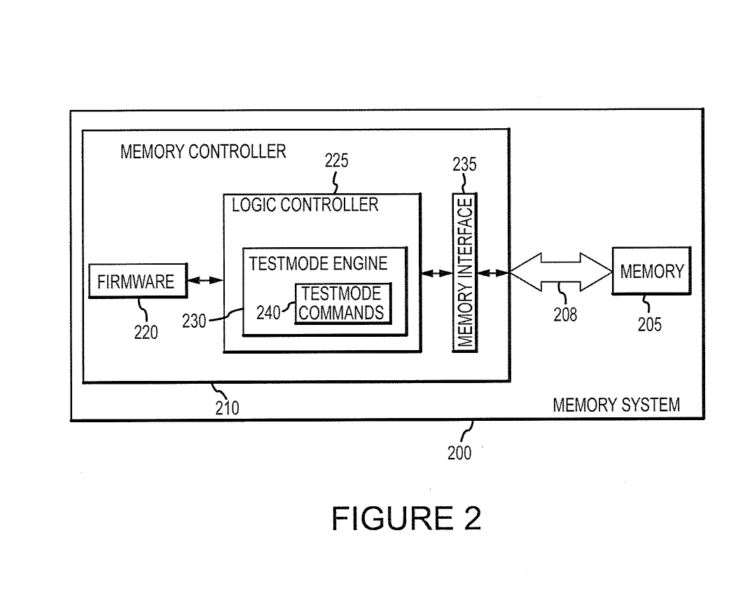

FIG. 2 is a schematic illustration of a memory system 200 arranged in accordance with an embodiment of the present invention. The memory system 200 may, for example, be a solid-state drive system. Generally, the memory system 200 may utilize a large amount of memory cells, e.g. memory cells included in the memory 205. The memory 205 may be connected to a memory controller 210 over a bus 208. A memory controller may be a distinct component from a higher-level controller, such as a system controller, or can be a sub-component of such a higher-level controller (in which case it may not necessarily be distinct from the system controller). The term “memory controller” as used herein, refers to either embodiment, and is not limited to either or only those embodiments.

The bus 208 may not be externally-accessible. For example, the memory 205 may be soldered onto a board that may also be soldered to the memory controller 210. The memory controller 210 and memory 205 on the board may be packaged into a single external housing or otherwise difficult to remove. In this manner, there may be no external access to the memory 205 for use by a separate test and/or repair system. Instead, the only access to the memory 205 in some examples may be through the memory controller 210.

The memory 205 may generally include any number and type of memory cells in any arrangement. For example, DRAM memory cells arranged in rows and columns may be used in one example. The memory 205 may include circuitry for entering a test mode and conducting testing and repair of the memory 205 while in test mode, analogous to the components shown in the memory die 100 of FIG. 1, except that in FIG. 2, there may not be any externally-accessible interface to the memory 205 for connection by a test system.

The memory controller 210 may include firmware 220 and a logic controller 225. While shown as firmware 220 and a logic controller 225, it is to be understood that the memory controller 210 may be implemented in hardware, software, or combinations thereof, and the firmware 220/logic controller 225 division shown in FIG. 2 is one example of a memory controller 210 implementation that may be used. The logic controller 225 may be configured to read data from and/or write data to the memory 205 in accordance with requests received by the memory controller 210 from a processor-based system with which the memory controller 210 is used, e.g. computing system (e.g. laptop, desktop, server), consumer device (e.g. camera, cellular phone, tablet, appliance), or other system. The logic controller 225 may be implemented, for example, using a DRAM controller when DRAM cells are used at least partially to implement the memory 205. Accordingly, the logic controller 225 may provide typical memory commands (e.g. combinations of RAS/CAS/WE, clock signals, CS/CKE, ADDR/DQ signals) to the memory 205 using a memory interface 235 of the memory controller 210. The designations RAS, CAS, WE, ADDR, DQ, CS, CKE, etc. generally refer to electrical connections (e.g. pins) between the memory controller 210 and the memory 205. Combinations of signals on these pins are used to provide commands, addresses, and data to the memory 205 during normal operation of the memory system 200.

The signals during normal operation may be provided over the bus 208 between the memory controller 210 and the memory 205. The logic controller 225, however, may further include a test mode engine 230. The logic controller 225 may, responsive to a signal provided from the firmware 220 or from a processor-based system to which the memory controller 210 is connected, allow the test mode engine 230 to control the memory interface 235 of the memory controller 210. The test mode engine 230 may provide signals to the memory 205 over the bus 208 between the memory controller 210 and the memory 205.

The signals provided by the test mode engine 230 may include a test mode entry signal that may be interpreted by the memory 205 as a command to enter a test mode of operation. When in a test mode operation, the memory 205 may interpret signals provided over the bus 208 differently than when in normal operation. For example, the same signals provided to the memory 205 during normal operation may cause a different action to be performed by the memory 205 than when those signals are provided to the memory 205 during a test mode operation. The test mode engine 230, however, may make use of the same bus 208 to provide a test mode entry signal. Accordingly, the test mode entry signal may be implemented using a combination of signals on connections (e.g. pins) ordinarily used by the memory controller 210 during normal operation, however, the combination of signals used to indicate test mode entry may be an illegal or otherwise unused combination during normal operation which would not be sent or not be able to be sent by the memory controller 210 during normal operation. The particular combination of signals that may be interpreted by the memory 205 as a test mode entry signal may be stored in the firmware 220. On an indication that test mode is desired, the logic controller 225 may provide control of the memory interface 235 to the test mode engine 230.

The test mode engine 230 may provide a test mode entry signal to the memory 205 over the bus 208 connecting the memory 205 and the memory controller 210. Generally, entry to test mode may be permitted after power-up of the memory system 200, including the memory 205, and when the memory 205 is in a stable or idle state. A sequence of test mode commands 240 may be loaded into the test mode engine 230 from, for example, the firmware 220, or may be provided from another portion of a processor-based system utilizing the memory system 200. Once in test mode, the test mode commands 240 may be provided to the memory 205 over the bus 208 between the memory 205 and the memory controller 210. The commands may similarly utilize DRAM commands typically used by the memory controller 210 during normal operation, over the same connections (e.g. pins such as RAS, CAS, WE, CKE, CS, DQ, and/or ADDR) but which may be interpreted differently in test mode.

For example, in one or more normal modes of operation, signals provided to a DRAM memory on RAS, CAS, and WE connections (e.g. pins) may be high, and a DRAM access may be initiated by transitioning a signal on the RAS connection (e.g. pin) low. In a test mode operation, however, the memory may instead be configured to interpret a low signal on the RAS connection (e.g. pin) as an indication to perform a repair operation, e.g. current repair. In the test mode operation, the test mode engine may provide signals to the memory that may repair the memory (e.g. program programmable elements of the memory to substitute redundant cells for failed cells).

When in test mode, the test mode engine 230 of FIG. 2 may in some examples adjust (e.g., alter or change) a frequency of a clock signal provided to the memory 205. For example, the test mode engine 230 may stop the clock provided to the memory 205. Stopping the clock may include holding a clock signal at a low level, or a high level, between provided commands. In this manner, a rising clock edge may be provided only when commands or other information are intended to be clocked in or out of the memory 205. In between those times, no clock rising edges may be provided. In other examples, the clock may continue to oscillate, but NOPs may be provided on the unused rising edges. NOPs may comprise, for instance, a command (e.g., a combination of signals) indicating that no operation may be executed in response to receipt of the NOP. On exit of the test mode, the clock signal may be restored (e.g., clock rising edges may be provided). In embodiments in which the clock is not stopped, in some instances, it may be necessary to setup one or more states of a plurality of test mode commands before issuing the plurality of test mode commands to the memory 205. In this manner, multiple commands may be setup and issued consecutively. Generally, a user (e.g. in firmware 210 and/or through a processor-based system to which the system 200 is coupled) may specify a correct order and series of test mode commands, e.g. test mode commands 240. The test mode commands may be stored in, for example, a series of registers accessible to the test mode engine 230.

In this manner, examples of test mode engines described herein, including the test mode engine 230 of FIG. 2, may be implemented in firmware in a memory controller, such as the firmware 220 of FIG. 2. The testmode engine may be implemented to control a flow and number of test mode commands, addresses, and data (e.g. writes and reads) to accomplish test mode functions (e.g. test mode entry, repair, exit, etc.), generally any functions supported by test mode of a connected memory (e.g. DRAM).

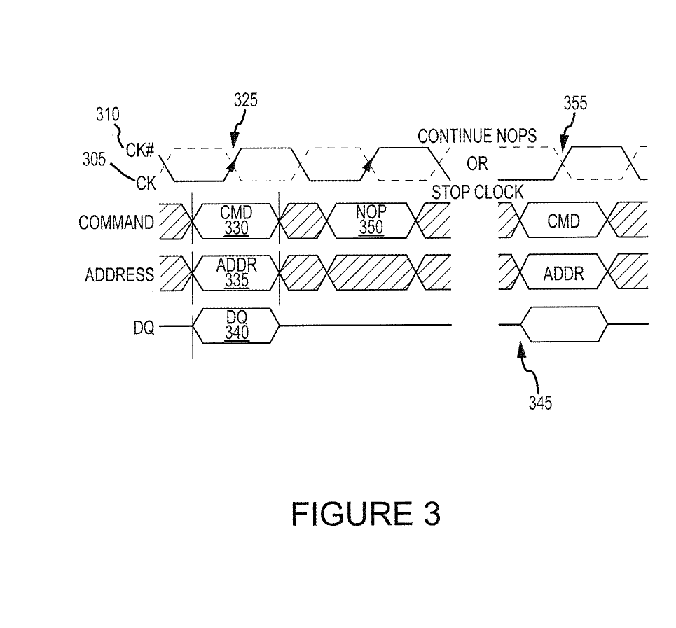

FIG. 3 is a timing diagram illustrating signal transitions corresponding to a command providing data to a memory during test mode in accordance with an embodiment of the present invention. For example, the timing diagram of FIG. 3 may be used to implement a write command in test mode. A clock signal, CK 305 and a complementary clock signal CK# 310 are shown. At a time 325 of a rising edge of the CK 305 signal, a command 330 may be provided by the test mode engine. The command may be a write command, and may have been stored in the test mode commands 240 shown in FIG. 2. The test mode engine may further provide Addr 335 and data DQ 340 signals at a same time. The command 330, Addr 335, and data DQ 340, in at least one embodiment, may be provided for a same amount of time. In another embodiment, one or more of the command 330, Addr 335, and data DQ 340 may be provided until a time 345 that a next command is provided by the test mode engine.

Following a time that the command 330 is provided, further NOPs may be provided as commands at subsequent rising edges of the CK 305 signal, such as the NOP 350. However, in other examples, the clock signal CK 305 may be stopped, and may maintain a logic low level until a transition 355 when a next command is provided by the test mode engine.

The data, such as the data 340, sent with commands, may further be stored in the test mode engine, such as the test mode engine 230 of FIG. 2, along with the test mode commands 240. Accordingly, the test mode engine 230 may be able to provide and/or capture data for a full width of the bus 208 between the memory controller 210 and the memory 205. Accordingly, if multiple memory devices are included in the memory 205, the test mode engine 230 may be able to capture and/or send data to all devices, sequentially in some examples, and in parallel in other examples. Data received from the memory 205 during test mode operation, which may be test mode data, not normal array data, may then be stored in the test mode engine 230 and/or other location accessible to the memory controller 210, e.g. in a set of registers. The test mode data may include, for example, states of registers in the memory 205 related to repair, and data regarding a present state of a particular row or column or other memory cell arrangement's repair.

Accordingly, for providing write commands, or other commands, the test mode engine such as the test mode engine 230 of FIG. 2, may be able to control DQ data for all data pins, DQ0-N, for each of a plurality of memory devices included in the memory being accessed in test mode. In some examples, the write data may be stored in advance in the test mode engine and may be provided as a single data word between, for example, the memory controller 210 and the memory 205 of FIG. 2,. Registers (e.g., read registers), examples of which are described further below, may be accessible to the test mode engine. In one embodiment, respective subsets of registers may be dedicated to read and write operations, respectively, such that the test mode engine will not be required to interleave write and read data. In other embodiments, a same set of registers may be used for both read and write operations such that the test mode engine may interleave read and write data. In some examples, a single data field per command may be provided and the data field masked to prevent it from being provided to certain devices in the memory 205. For example, one register may be provided in communication with the test mode engine 230 of FIG. 2 which has a width of N bits. A mask per device may be provided on the bus 208. In this manner, memory devices used to implement the memory 205 may be tested serially where 0-N bits are presented to one device with the rest being “masked.” Both the data register and a mask register per device may be set pursuant to a stop-clock command. Generally, the devices may be tested in any order.

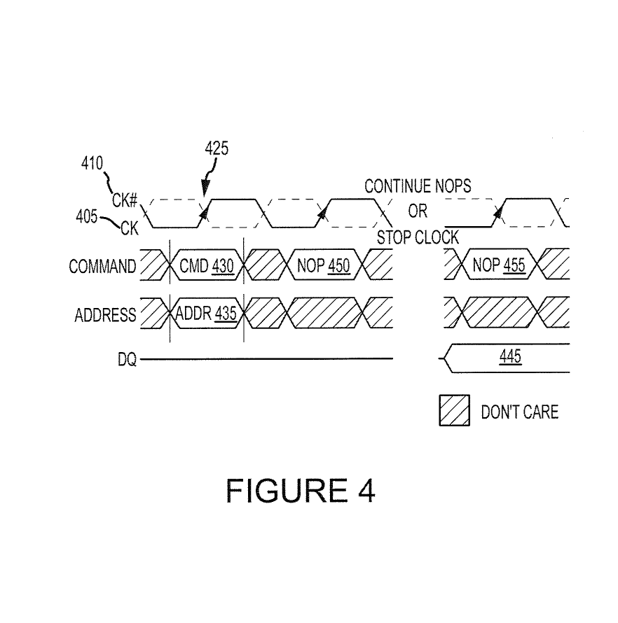

FIG. 4 is a timing diagram illustrating signal transitions corresponding to a command reading data from a memory during test mode in accordance with an embodiment of the present invention. A clock signal CK 405 and a complementary clock signal CK# 410 are shown. At a transition 425 of the clock signal CK, a command 430 may be provided to a memory by a test mode engine, such as the test mode engine 230 of FIG. 2. The command 430 may be a read command and may be provided using a combination of signals able to be provided by the memory controller 210 of FIG. 2. During a same rising edge of the clock signal, address signals Addr 435 may be provided to the memory. At a time following the provision of the command and address signals, e.g. at time 440 in FIG. 4, data 445, may be available from the memory for receipt at the test mode engine. The data may be available on DQ pins independent of any clock signal. In some examples, the test mode engine may be configured to provide one or multiple NOPs after data becomes available, such as the NOP 455 in FIG. 4, to allow time for data capture prior to execution of another test mode command. In some examples, the test mode engine may include a control bit in each command to indicate whether to strobe for data in that command. Data may be read by the test mode engine in accordance with the clock signal CK 405 or CK# 410 or in accordance with a toggling DQS signal (not shown). The DQS signal may be based, at least in part, on the clock signal CK 405. In other embodiments, in addition to or in lieu of control bits, NOP commands and associated mode register set commands may be configured such that data is not driven on the bus in response to these commands.

The data 445 may be test mode data. The test mode data may not be normal array data (e.g. the test mode data may not reflect data stored in cells of the memory 205 of FIG. 2). For example, the data 445 may not be data read from a particular address in memory as may be the case during a normal operation of the memory. Instead, the data 445 may represent test mode data, which may include data generated by the memory during test mode, for example representing a number or location of failed memory cells, a number or location of available redundant memory cells for replacement, or combinations thereof. Between commands, in some examples, the clock signals 405 and 410 may continue to toggle and NOP commands may be provided, such as NOPs 450 and 455. In other examples, NOPs may not be provided and the clock signals 405 and 410 may not toggle, they may be stopped (e.g. maintained at a same logic level).

Generally, the test mode engine 230 of FIG. 2 may be able to capture data from the entire bus 208 (e.g. a DQ0-N) bus. In some examples, the memory 205 may include a plurality of memory devices. The test mode engine 230 may provide a test mode entry signal to one or a selected subset of the plurality of memory devices in the memory 205, or to all of the memory devices 205 in some examples. The memory devices in test mode may be operated on (e.g. repaired) in parallel or individually. In some examples, all memory devices of the memory 205 may be placed in test mode and the command/data/address signals for writes and data received during read operations may be provided and/or captured either in serial or parallel for the memory devices in the memory 205. In some examples, all DQ0-N pins for each memory device accessible on a bus, e.g. the bus 208 of FIG. 2, may be captured following a read command. In some examples, multiple devices may be accessible on a bus 208. Accordingly, it may be desirable to capture all DQ0-N pins for each of those devices. In some examples, the DQ0-N per device may be captured serially or may be captured in parallel. Accordingly, in some examples a test mode engine may be in communication with a number of data registers. In one example, each data register may correspond with a different device accessible to the test mode engine. For example, the memory 205 of FIG. 2 may include a plurality of memory devices. The test mode engine 230 may include or be in communication with a plurality of data registers, with selected ones of the data registers corresponding to selected ones of the plurality of memory devices. Data read from the memory devices responsive to a test mode read command may be placed in the registers in a consistent manner (e.g. the same DQ0-N orientation for each register). The test mode engine may continue to provide NOP commands and capture difference device DQ0-N pins as the registers are loaded with data from each memory device on the bus 208. As mentioned above, in some examples, these data registers may also be used for storing write data for provision to the memory devices. In at least one embodiment, the test mode engine may be configured to provide only read commands or only write commands during a respective series of operations.

During operation, referring back to FIG. 2, in examples of the present invention a memory controller 210 may include a logic controller 225 and test mode engine 230. On receipt of an indication to enter test mode, the logic controller 225 may provide control of the memory interface 235 to the test mode engine 230. The test mode engine 230 may provide a combination of signals to the memory 205 that indicate to the memory to enter test mode. The test mode engine 230 may send test mode commands to the memory 205. Examples of test mode commands and their delivery have been described above. In some examples, a clock provided to the memory 205 is stopped between test mode commands. Generally, the test mode commands cause the memory to respond differently than during normal operation because the memory 205 is in test mode. For example, the test mode commands may affect repairs on the memory 205, such as by blowing fuses or other programmable elements to substitute redundant rows for failed rows. Test mode data may be read from the memory 205, and the test mode data may be different than normal array data. The test mode data may include, for example, a number or location of available redundant rows or columns.

In the example of FIG. 2, the memory 205 may have already been tested or tested by a different system to obtain the location of memory fails. Locations of memory fails may, for instance, comprise addresses (e.g., row addresses) having one or more defective memory cells. The location of memory fails may be loaded into the firmware 220 and/or the logic controller 225. The test mode engine 230 may accordingly provide test mode commands 240 for repairing the location of memory fails.

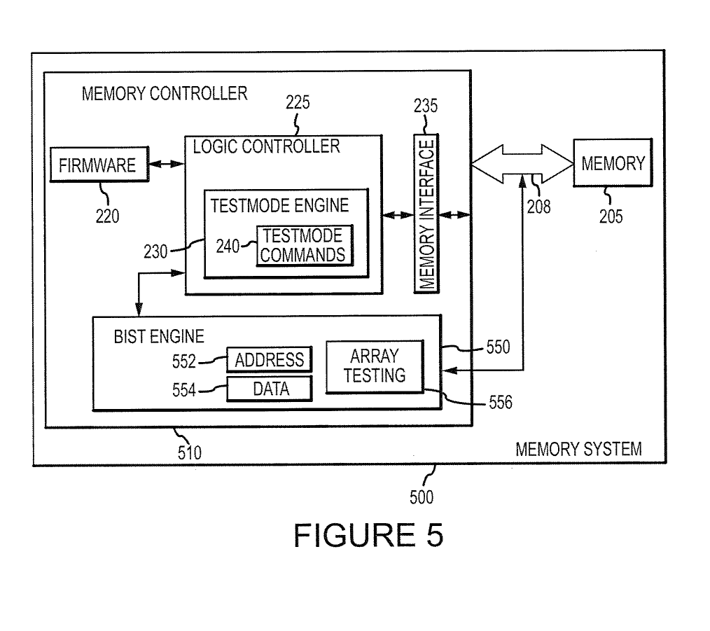

FIG. 5 is a schematic illustration of a memory system arranged in accordance with another embodiment of the present invention. The memory system 500 may include many analogous components to the memory system 200 of FIG. 2, with the same reference numbers used in FIG. 5 for like components, whose detailed operation will not be repeated here. The memory system 500 includes a memory controller 510 that may include or be in communication with a built-in self test (BIST) engine 550. The BIST engine 550 may allow for the memory system 500 itself to test the memory 205. The BIST engine 550 may include address 552 and data 554 storage and may further include an array testing block 556 for generating patterns of address and data information for use in testing the memory 205. The BIST engine 550 may provide the address and data information, which may be specified (e.g., generated) by the array testing block 556, to the logic controller 225. The array testing block 556 may comprise a pattern generator (e.g., algorithmic pattern generator) and may store the address and data information and/or generate the address and data information in real-time. The logic controller 225 may accordingly test the memory 205 using the memory interface 235 and/or the bus 208. In some examples, the BIST engine 550 may have its own connection to the bus 208 for directly testing the memory 205.

In this manner, the memory controller 510 may conduct testing of the memory 205. Locations of memory fails may be stored in the firmware 220, BIST engine 550, logic controller 225, test mode engine 230, or combinations thereof. The locations of memory fails may be stored in fail registers which are readable during test mode. The memory controller 510 may further repair the memory 205 by loading the locations of memory fails from the location in which they were stored and providing those locations to the test mode engine 230. The test mode engine 230 may repair the memory 205 by placing the memory 205 into test mode and providing commands to effect memory repairs, as generally described above.

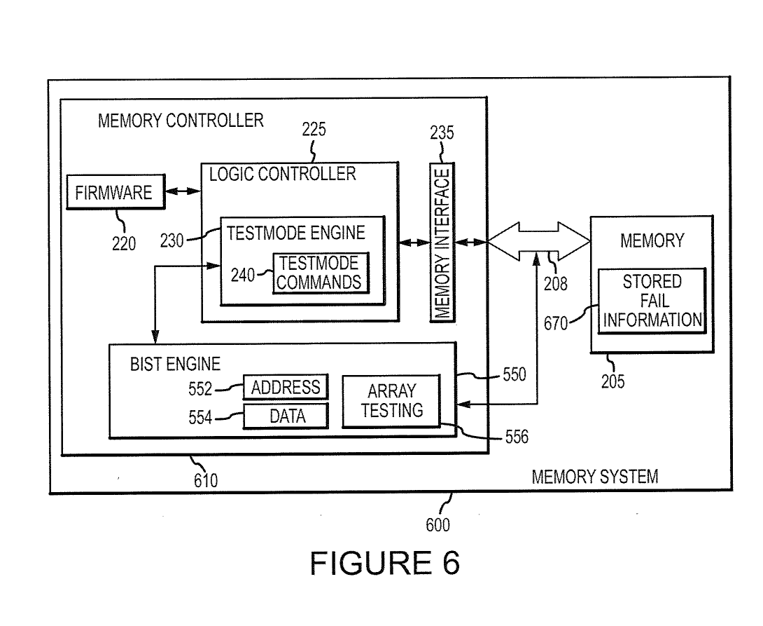

FIG. 6 is a schematic illustration of a memory system arranged in accordance with another embodiment of the present invention. The memory system 600 may include many analogous components to the memory system 200 of FIG. 2 and the memory system 500 of FIG. 5, with the same reference numbers used in FIG. 6 for like components, whose detailed operation will not be repeated here.

The memory system 600 may include a memory controller 610 which may include or be in communication with a BIST engine 550. The BIST engine 550 may be in communication with the test mode engine 230 such that the test mode engine 230 may conduct the testing of the memory 205 over the memory interface 235 and bus 208. In some examples, the BIST engine may have its own connection to the bus 208 for directly testing the memory 205. When the BIST engine 550 is in communication with the test mode engine 230, fail information 670, e.g. fail locations, may be stored in the memory 205 itself and later used by the test mode engine 230 to conduct a repair. For example, if the test mode engine 230 had placed the memory 205 into test mode before array testing and maintained testmode during array testing, then the fail information 205 may be stored in the memory 205. Accordingly, there may not be a need to externally store and load information regarding the location of failed memory rows, columns, or cells.

Accordingly, the test mode engine 230 may include test mode commands 240 which may be used to repair the memory 205 while the memory 205 is in test mode. When a BIST engine 550 is provided in communication with the memory 205, array testing of the memory 205 may be performed over the bus 208, and in at least some embodiments, if the memory 205 is in test mode, fail information may be stored in the memory 205 (see, e.g. FIG. 6). However, during array testing, it may be necessary to prevent the memory 205 from exiting test mode as doing so may result in improper operation. For example, if test mode commands were provided by the memory controller 510 as normal mode commands, improper operation may result.

The test mode engine 230 may accordingly be configured to prevent the memory 205 from exiting test mode during array testing. For example, the test mode engine 230 may be configured to prevent signals from being provided to the memory 205 that would cause the memory 205 to exit test mode, such as a reset., In at least one embodiment, the test mode engine 230 may be configured to prevent the memory 205 from exiting test mode by using information stored in the firmware 220 or by selecting an appropriate sequence of test mode commands 240. In some examples, the test mode engine 230 may configure the BIST engine 550 to conduct array testing without providing any commands to the memory 205 that may cause all or a part of the memory 205 to exit test mode. For example, the test mode engine 230 may specify a range of addresses for test and that no resets be provided from the BIST engine 550 during array testing. In some examples, the criteria for exiting test mode that the BIST engine should be prohibited from providing to the memory 205 may be stored in the firmware 220.

Following the array test, test mode commands 240 may be loaded that may correspond to commands to repair the memory 205. The commands may be provided to the memory 205 and the memory repaired in accordance with the stored fail information 670.

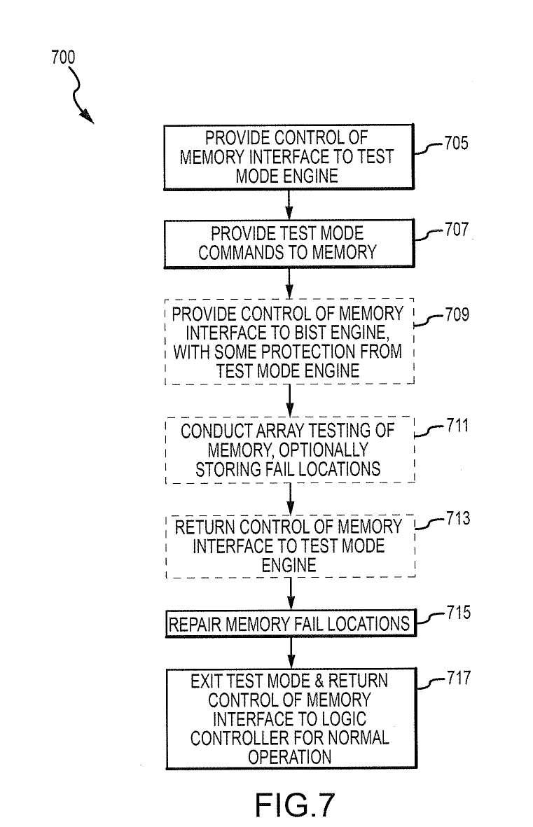

FIG. 7 is a flowchart illustrating operation of a memory system in accordance with an embodiment of the present invention. During operation of example memory systems including testing and/or repair capability described herein, such as the memory systems 500 and 600 of FIGS. 5 and 6, the memory systems may perform the method 700 shown in FIG. 7. In block 705, control of a bus, e.g. the bus 208 of FIGS. 5 and 6, may be provided to a test mode engine in block 705. The test mode engine may accordingly determine what signals are provided to a memory by a memory controller during normal operation. Control may be provided to the test mode engine by the memory controller responsive to an indication that test mode is desired which may be received from a processor-based system with which the memory system is in communication.

In block 707, a memory controller may provide signals to memory to enter a test mode. The signals may be provided by the test mode engine and may be provided on connections (e.g. pins) used during normal operation of the memory. However, the signals indicative of test mode entry may represent a normally illegal combination of signals in normal operation. As described herein, a clock signal provided to the memory may be stopped and/or the frequency of the clock signal reduced between test mode commands.

When a BIST engine is present in the memory system, control of the bus may be provided to the BIST engine in block 709. If a stopped or slowed clock had been used for providing test mode commands, the clock may be adjusted to a suitable frequency for BIST or other test operations. Accordingly, the clock provided to the memory 205 during array testing may be adjusted or stopped again when doing more testmode operations. The test mode engine may provide an indication to the BIST engine that it may now control the bus between the memory controller and the memory for testing of the memory. However, the test mode engine may provide some protection to the operation of the BIST engine. For example, the test mode engine may set up the BIST engine in accordance with settings from the memory controller firmware such that the BIST engine does not cause the memory to exit test mode during array testing. Accordingly, in block 711, array testing of the memory may be performed by the BIST engine. If the memory is in test mode, fail locations may also be stored in the memory. As described herein, in other examples, fail locations may be stored in other locations such as the test mode engine, the firmware, or other locations in communication with the memory controller.

Once testing is complete, in block 713, control of the bus may be returned to the test mode engine. For example, the BIST engine may provide an indication to the test mode engine that array testing is complete, and the test mode engine may resume control of the bus between the memory controller and the memory.

Test mode data (e.g. fail information, such as fail locations) may be used by the testmode engine for repairing the memory. In block 715, the memory may be repaired. For example, programmable elements may be programmed to substitute one or more redundant memory locations for the fail locations. The fail locations may either already be stored in the memory, or may be loaded by the test mode engine or other portion of the memory controller from a different location where they were stored following test.

In block 717, test mode may be exited, and control of the bus may be returned to a logic controller for normal operation of the memory. The test mode engine may, for example, provide a combination of signals to the memory that, when in test mode, are interpreted by the memory as being an indication to exit test mode and enter normal operation mode. The combination of signals may be a combination that is typically illegal during normal mode of operation in some examples. The test mode engine may provide an indication to the logic controller that test mode has been exited and return control of a memory interface to the logic controller.

Examples of memory systems shown and/or described herein may be implemented in any of a variety of products employing processors and memory including for example cameras, phones, wireless devices, displays, chip sets, set top boxes, gaming systems, vehicles, and appliances. Resulting devices employing the memory system may benefit from the examples of test mode engines, testing and repair operations described herein to perform their ultimate user function.

From the foregoing it will be appreciated that, although specific embodiments of the invention have been described herein for purposes of illustration, various modifications may be made without deviating from the spirit and scope of the invention.

What is claimed is:

1. An apparatus
configured to read data from and write data to memory during normal operation of a memory system over a bus, wherein the apparatus comprises:
a test mode engine configured to control the bus responsive to an indication that a test mode of operation is desired, wherein the test mode engine is configured to provide the memory with a signal indicative of entering the test mode of operation over the bus; and
a built-in self test (BIST) engine configured to provide signals for testing the memory over the bus, wherein either the BIST engine or the test mode engine is configured to provide the signals for testing the memory to the bus.

2. The apparatus of claim 1, wherein the bus is not externally accessible.

3. The apparatus of claim 1, wherein the test mode engine is configured to provide the signal indicative of entering the test mode of operation to one or a subset of a plurality of devices in the memory.

4. The apparatus of claim 1, wherein the signal indicative of entering the test mode of operation comprises a combination of signals that would be illegal during normal operation of the memory.

5. The apparatus of claim 1, wherein the test mode engine is further configured to provide control of the bus to the BIST engine responsive, at least in part, to providing the signal indicative of entering the test mode of operation over the bus.

6. The apparatus of claim 5, wherein the BIST engine is further configured to provide control of the bus to the test mode engine responsive, at least in part, to providing the signals for testing the memory to the bus.

7. The apparatus of claim 1, wherein the bus comprises solder traces on a printed circuit board.

8. The apparatus of claim 1, wherein the memory comprises an array of DRAM memory cells.

9. The apparatus of claim 1, wherein the test mode engine is included in a logic controller that is configured to provide the signals for testing the memory to the bus, and wherein the apparatus comprises a memory controller configured to store test mode data received from the memory in a location accessible to the memory controller.

10. The apparatus of claim 1, wherein the test mode engine is further configured to cause repair of the memory during the test mode operation.

11. The apparatus of claim 1, wherein the test mode engine is configured to provide signals for testing the memory to the memory interface, and wherein test mode data including locations of failed memory are stored in the memory.

12. The apparatus of claim 11, wherein the signals for testing the memory comprise data, address, and command signals.

13. A method of repairing a memory system, the method comprising:
loading a plurality of test mode commands into a test mode engine of a memory controller;
providing a signal indicative of entering a test mode of operation from the test mode engine to a memory, wherein the signal is provided over a same bus used by the memory controller during normal operation of the memory;
entering test mode operation at the memory responsive to receipt of the signals indicative of entering the test mode operation; and
during test mode operation, receiving signals for testing of the memory from a built-in self test (BIST) engine in communication with and/or included in the memory controller.

14. The method of claim 13, further comprising:
returning fail information responsive to the address and data signals for testing of the memory; and
causing the memory to be repaired, using the test mode engine and at least one of the plurality of test mode commands in accordance with the fail information.

15. The method of claim 13, further comprising:
storing fail information in the memory responsive, at least in part, to the address and data signals for testing of the memory.

16. The method of claim 13, further comprising:
preventing, with the test mode engine, the memory from exiting test mode operation.

17. The method of claim 13, wherein the signal indicative of entering a test mode of operation comprise a combination of signals including RAS, CAS, WE, or CS.

18. The method of claim 13, wherein the memory controller comprises a solid-state drive (SSD) controller.

19. The method of claim 13, wherein the memory comprises a plurality of DRAM memory cells.

20. The method of claim 13, wherein the test mode engine is configured to provide the signals for testing the memory to the memory.

21. The method of claim 13, wherein the fail information is stored in the memory controller.

22. The method of claim 13, wherein the fail information comprises fail locations.

23. A memory controller configured to read data from and write data to a memory during normal operation over a bus, wherein the controller comprises:
a test mode engine configured to provide a test mode command to the memory and receive test mode data responsive to the test mode command, wherein the test mode data includes data generated by the memory during a test mode.

24. The memory controller of claim 23, wherein the test mode engine is configured to mask a data field of the test mode command.

25. The memory controller of claim 23, wherein the test mode engine is configured to include a control bit in the test mode command to indicate whether to strobe for data.

26. The memory controller of claim 23, wherein the test mode engine is configured to setup one or more states of the test mode command prior to providing the test mode command to the memory.

27. The memory controller of claim 23, wherein the test mode data includes a number of, or location of available redundant memory locations, or both.

28. The memory controller of claim 23, wherein the test mode data includes a number of or location of failed memory locations, or both.

29. The memory controller of claim 23, wherein the memory controller is configured to provide control of the bus to the test mode engine responsive to an indication of test mode operation being desired.

30. The memory controller of claim 23, wherein the test mode commands are loaded from firmware of the memory controller.

31. A method for repairing memory, the method comprising:
loading at least one test mode command in a test mode engine of a memory controller;
providing a signal from the memory controller to memory, wherein the signals are configured to cause the memory to enter a test mode of operation;
providing the at least one test mode command to the memory over a bus;
receiving test mode data from the memory responsive to the at least one test mode command, wherein the test mode data comprises data generated by the memory during test mode; and
causing the memory to be repaired, using the test mode engine, in accordance with the test mode data.

32. The method of claim 31, wherein the test mode data includes a number of, or location of available redundant memory locations, or both.

33. The method of claim 31, wherein the test mode data includes a number of or location of failed memory locations, or both.

34. The method of claim 31, further comprising storing the test mode data in a location accessible to the test mode engine.

35. The method of claim 31, further comprising loading a plurality of fail locations and wherein said repairing comprises replacing the fail locations in accordance with the test mode data.

36. The method of claim 31, wherein the memory controller is configured to read data from and write data to the memory over the bus during normal operation of the memory.

37. A memory controller configured to read data from and write data to a memory over a bus in accordance with a clock signal during normal operation of the memory, wherein the memory controller comprises: a test mode engine configured to place the memory into a test mode of operation, receive test mode data from the memory over the bus during the test mode of operation, and cause the memory to be repaired over the bus during the test mode of operation, wherein the test mode engine is configured to adjust a frequency of the clock signal and provide at least one loaded test mode command to the memory during the test mode of operation.

38. The memory controller of claim 37, wherein the test mode engine being configured to adjust the frequency of the clock signal comprises the test mode engine being configured to stop the clock signal between test mode commands provided to the memory.

39. The memory controller of claim 38, wherein the test mode engine being configured to stop the clock signal comprises the test mode engine being configured to hold the clock signal at a low level between test mode commands provided to the memory.

40. The memory controller of claim 37, wherein the test mode engine being configured to adjust the frequency of the clock signal comprises the test mode engine being configured to reduce the frequency of the clock signal during the test mode of operation.

41. The memory controller of claim 37, wherein the test mode engine being configured to adjust the frequency of the clock signal comprises the test mode engine being configured to provide NOP commands to the memory at rising edges of the clock signal falling between test mode commands.

42. The memory controller of claim 37, wherein the test mode engine is further configured to restore the clock signal on exiting the test mode of operation.

43. A method for repairing memory, the method comprising:
placing a memory into a test mode of operation at least in part by providing a signal to the memory from a test mode engine of a memory controller over a bus used during normal operation of the memory;
providing a test mode command to the memory during the test mode of operation;
adjusting a frequency of a clock signal provided to the memory during the test mode of operation;
receiving test mode data from the memory; and
repairing the memory in accordance with the test mode data.

44. The method of claim 45, wherein said adjusting a frequency of a clock signal comprises stopping the clock signal between test mode commands.

45. The method of claim 44, wherein said stopping the clock signal comprises holding the clock signal at a low level between test mode commands.

46. The method of claim 43, further comprising restoring a frequency of the clock signal and returning the memory to the normal operation.

47. A memory controller configured to read data from and write data to a memory over a bus in accordance with a clock signal during normal operation of the memory, wherein the memory controller comprises:
a test mode engine configured to place the memory into a test mode of operation, receive test mode data from the memory over the bus during the test mode of operation, and cause the memory to be repaired over the bus during the test mode of operation, wherein the test mode engine is configured to provide at least one NOP command and at least one loaded test mode command to the memory during the test mode of operation.

48. The memory controller of claim 47, further comprising:
a plurality of registers, each of the plurality of registers corresponding to a device of the memory, respectively, and configured to store data during the test mode of operation.

49. The memory controller of claim 47, wherein the at least one NOP command is configured to not provided on the bus responsive, at least in part, to the NOP command.
